(19) United States
(12) Patent Application Publication
(10) Pub. No.: US 2003/0062221 A1
(43) Pub. Date: Apr. 3, 2003

(54) Oil filter containment receptacle

(76) Inventors: Thomas Marvin Burrow, Bell Canyon, CA (US); Christopher Gamble, Canoga Park, CA (US)

Correspondence Address: Gregory J. Nelson, NELSON & ROEDIGER, Suite 212, 3333 E. Camelback Road, Phoenix, AZ, 85018, US

(21) Appl. No.: 09/967,651

(22) Filed: Oct. 1, 2001

(51) Int. Cl. F16C 3/14

(52) U.S. Cl. 184/1.5

(57) ABSTRACT

a flexible, bag-like, receptacle for use when removing a vehicle oil filter. The receptacle has a body which is larger at the open upper end to receive the filter and to catch drips and spills. After the filter is removed by grasping the exterior of the receptacle and contained filter, the contents may be sealed for disposal. In one embodiment, the receptacle has an integrally formed glove or mitt.

### FIELD OF THE INVENTION

The present invention relates to a containment receptacle to minimize spillage and more particularly relates to a receptacle for receiving and containing a vehicle oil filter to collect drips as the oil filter is removed minimizing spillage and messiness.

### BACKGROUND OF THE INVENTION

The procedure for removing an oil filter from a vehicle, such as an automobile, generally involves first the loosening the metal band that extends around the oil filter using a suitable wrench. After the band is loosened, the oil filter is manually unscrewed from the engine block so that it can be removed. As the oil filter is removed, residual oil, which is trapped by the filter, will often spill out onto the shop floor surface and also may soil the hands and clothing of the mechanic changing the oil filter.

Various devices are available to minimize spillage when removing an oil filter. The simplest, and widely used, is in the form of an adjustable funnel and which can be placed beneath the oil filter so that, as the oil filter is removed, oil will be caught and collected in the funnel and directed to a suitable container. However, oil can still spill and often will run down the arm of the person soiling clothes, as well as the hands of the person as the filter is disengaged from the engine block.

In an approach to this problem, U.S. Pat. No. 4,020,922 shows a tool for use by a mechanic when changing an oil filter which prevents the mechanic from being burned by hot oil running from the engine block. The tool consists of a disposable plastic bag which is attachable to an adapter. The adapter and bag are fitted around the lower portion of the engine block and the oil filter depends into the bag. This permits the mechanic to place a wrench around the outer side of the bag in order to grasp the filter to unscrew the filter from the engine block. The removed oil filter drops into the bag with the dripping oil so that the oil does not run down the mechanic's arms.

U.S. Pat. No. 3,385,141 entitled “Oil Filter Glove Having Internal Spaced Filter Engaging Elements” shows a glove which may be placed about the exterior of an oil filter having gripper elements.

Despite the various attempts of dealing with the problem of clean and efficient removal of oil filters from engine blocks, there nevertheless exists a need for an improved device which will permit the task to be done cleanly and with minimum soiling.

### BRIEF SUMMARY OF THE INVENTION

Accordingly, it is a principle object of the present invention to provide an oil and oil filter containment receptacle which permits the user to place the bag about the filter and then loosen and remove the oil filter from the engine block containing the filter and the oil drippings.

It is another object of the present invention to provide a filter containment receptacle which is simple in design, inexpensive to manufacture and is disposable so that it may be sealed to contain the residual oil and oil filter for proper disposal.

Briefly, the present invention comprises a flexible receptacle, such as a poly bag, having a tapered wall which can be placed about the filter to collect drips. The bag has a closure which seals the filter within the bag after removal. The bag may include non-slip gripping surface as well as an integral glove or mitt which facilitates grasping the filter to unscrew and remove it.

### BRIEF DESCRIPTION OF THE DRAWINGS

The above and other object of the present invention will become more apparent upon reading of the following specification and accompanying drawings in which:

FIG. 1 is a view of a filter containment receptacle according to the present invention showing a filter within the catcher or containment receptacle;

FIG. 2 is a view of another embodiment of the containment receptacle of the present invention;

FIG. 3 is a view of another embodiment of the containment receptacle of the present invention; and

FIG. 4 shows yet another embodiment of the present invention.

### DETAILED DESCRIPTION OF THE DRAWINGS

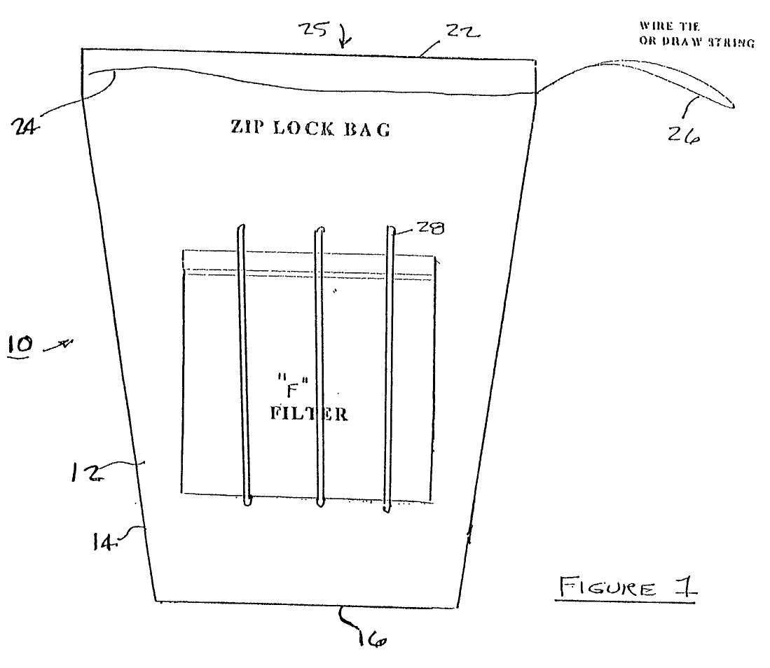

Turning now to the drawings, particularly FIG. 1, the containment receptacle of the present invention is generally designated by the numeral 10. The containment receptacle is in the form of a receptacle having a bag 12 of a suitable, flexible material such as polyvinyl film of suitable thickness such as 3 to 5 mm. Preferably the bag material is transparent so the user may clearly view the oil filter during removal. The body of the bag 12 has a tapering sidewall 14 and is somewhat in the shape of a truncated cone having a bottom 16 which is suitably sealed to form an enclosure 25. The upper end of the bag is open at 22 but may be closed by a suitable closure member 24 such as a type of seal known as a Ziplock seal or other closure such as a wire or drawstring 26. The dimensions of the bag may vary but preferably the opening at the upper or mouth end should exceed the diameter of the oil filter removed. The bottom of the bag 16 has a diameter slightly exceeding the diameter of the filter “F” to be removed.

As seen in FIG. 1, the bag is placed over the filter “F” after any retaining bands have been loosened or removed. With the filter F inside the bag, as shown in FIG. 1, the user may grasp the exterior of the bag and rotate it to unscrew it from the engine block. The tapering sidewalls and the opening of the upper end or mouth 22 are positioned against the engine block and will catch any drippings or oil released as the filter is removed. Once the filter is fully unscrewed, the filter and any oil collected in the removal process are contained within the bag. The bag may be sealed by the closure 24 or the wire tie or drawstring 25, and transported for disposal in accordance with applicable regulations.

It will be appreciated that the bag, having tapering sidewalls, will minimize spillage. The filter contained in the bag insulates the user from direct contact with the filter so that the user's hands do not become oily and soiled.

To assist the user in unscrewing the oil filter, the inner surface of the bag may be provided with gripping surfaces in the form of roughened areas or ridges 28 which will be brought into engagement with the filter as the bag is manually compressed about the filter during the removal operation. The surfaces 30 may be formed as part of the bag or applied to the interior by an adhesive.

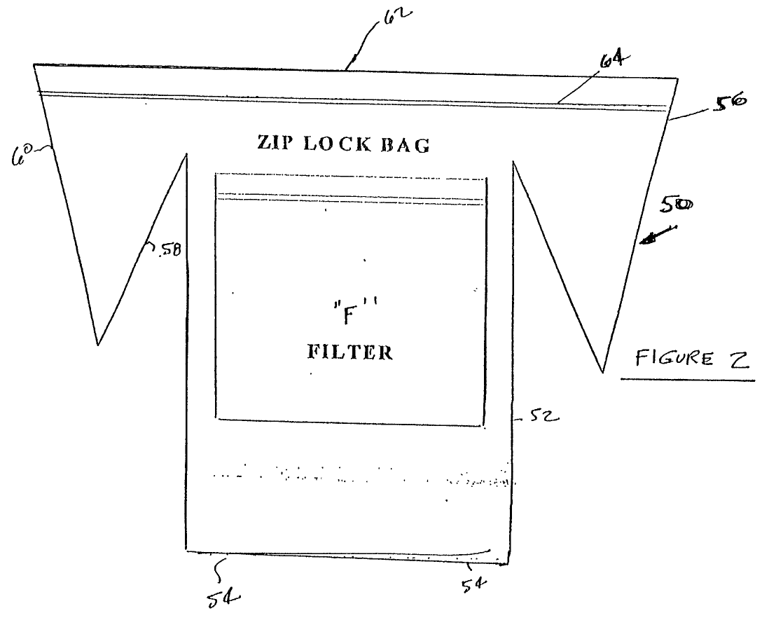

FIG. 2 shows another embodiment of the oil filter removal device of the present invention generally designated by the numeral 50. In this embodiment, the device is again in the form of a bag of transparent, flexible material such as polyvinyl having a body 52. The body 52, as shown, is generally cylindrical having a diameter somewhat greater than the diameter of filter “F” to be removed. The lower end of the cylindrical body portion is sealed at 54. The body extends upwardly to enlarged mouth section 56 formed by a downwardly depending annular pleat section 58 and an outer diverging circumferential wall section 60. The outer wall 60 defines a large upper opening or mouth 62. A suitable closure 64 extends across the width of the mouth and the closure may again be a Ziplock-type closure, a drawstring, a wire tie or other similar closure.

The use of the filter receptacle device of FIG. 2 is similar to that as described above with reference to FIG. 1. The bag is positioned with the body of the bag around the filter as shown in FIG. 2 after any retention bands have been loosened or removed. The wide mouth of the bag is positioned around the filter adjacent the engine block.

The user may then grasp the body portion 52 compressing it about the filter so the filter may be unscrewed. The user may maintain the mouth 62 against the engine block with the opposite hand. As the filter is loosened, the filter will be contained within the bag. Any oil spillage or leakage that occurs as the filter is loosened will be caught by the widened upper section of the bag. Once the filter has been removed, the receptacle can be sealed and the filter and contained oil disposed of in accordance with environmental regulations.

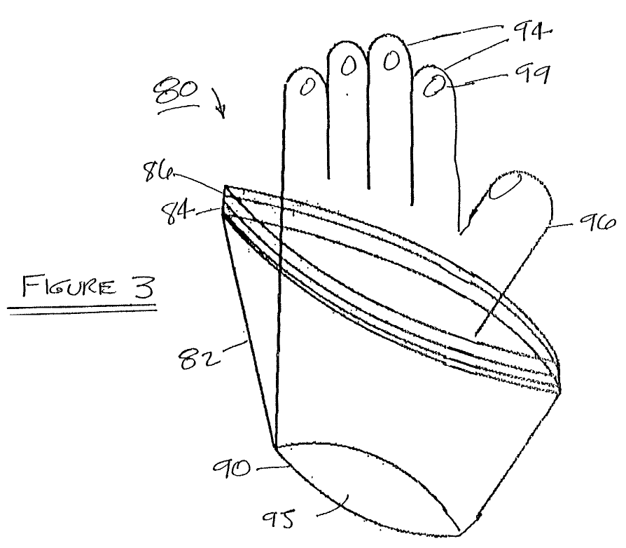

In FIG. 3, yet another embodiment of the present invention, as shown, generally designated by the numeral 80. In this embodiment, the receptacle has a body 82 of flexible, transparent, chemically resistant material such as 5 mm PVC. The sides of the body taper outwardly along 82 to upper end or mouth 84 across which extends a closure 86. Again, the closure may be a Ziplock-type closure as is well known in the packaging arts. The bottom 90 of the receptacle is formed having a glove portion 92 with finger pockets 94 and thumb pocket 96. The glove and body are formed as a unitary structure with an upwardly extending opening 95 into which the user may insert his or her hand into the glove portion. Thus, as it will be seen that, in use, the mechanic will insert a hand into the opening 95 with the fingers in the finger pockets 94 and the thumb in the thumb pocket 96. The user may then grasp the oil filter using the glove portion and proceed to loosen the oil filter. The wide mouth 84 extending circumferentially around the glove will catch oil drippings. Once the oil filter is removed, the user will then be able to withdraw the glove portion 92 into the mouth of the body portion so that the filter is contained within the body portion of the bag along with oil drippings. Once the filter is within the bag, the bag may be closed and the bag and contained oil filter is ready for disposal.

To assist in removing or unscrewing the oil filter, the ends of the finger pockets 94 may be provided with ridges or roughened surfaces 99 which will assist to avoid slippage.

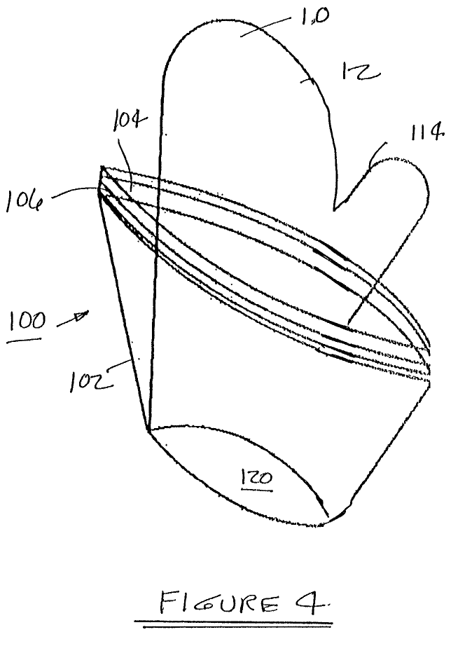

FIG. 4 shows yet another embodiment of the present invention which is similar to that shown in FIG. 3. In this embodiment, the receptacle is generally designated by the numeral 100 and again has a body 102 with tapering sidewalls which, at the upper end, form an opening 104 having closure member 106. Integrally formed with the body is a mitt 110 having a pocket 112 for receipt of the fingers of the user and a thumb pocket 114. The glove defines an opening 120 for receipt of the user's hand.

The user will insert his or her hand into the opening 120 so that the fingers extend into the finger pockets and the thumb into the thumb pocket. The user may then grasp the oil filter with the glove portion removing the oil filter. The widened upper opening or mouth 14 has a diameter greater than the oil filter and will be maintained in a position to surround the opening in the engine block. Oil drippings will be caught within the body 102. Once the filter is loosened, the glove and filter can be moved to a retracted or withdrawn position within the body at which time the user may then remove his or her hand from the glove and proceed to seal the bag in dispose of the oil filter.

It will be seen that the present invention provides a filter catcher which assists a mechanic or other user in removing an oil filter and to minimize spillage and to maintain oil out of contact with the user's hands during the operation. Further, the present invention will catch oil drippings and enclose the oil drippings, along with the removed filter, in a sealed container for environmentally acceptable disposal.

The oil filter catcher of the present invention is inexpensive to manufacture, convenient to use and may be provided to mechanics as a promotional item with purchase of oil filters or, in the case of professional mechanics, can provided in dispensers for easy access, removal and use.

It will be obvious to those skilled in the art to make various changes, alterations and modifications to the invention described herein. To the extent these various changes, alterations and modifications do not depart from the spirit and scope of the appended claims, they are intended to be encompassed therein.

We claim:

1. A receptacle for use in removing an oil filter to receive the filter and oil comprising a generally flexible bag having a bottom, upwardly tapering sidewall and an open mouth having a closure member.

2. The receptacle of claim 1 wherein said receptacle includes an integrally formed hand receiving portion extendable through the mouth to allow the user to grasp the oil filter and remove it into the receptacle out of contact with the filter.

3. The receptacle of claim 1 further including areas on the receptacle for increased frictional engagement with the filter.
